(19) United States
(12) Patent Application Publication
(10) Pub. No.: US 2020/0124134 A1
(43) Pub. Date: Apr. 23, 2020

(54) DYNAMIC DAMPER DEVICE

(71) Applicant: EXEDY Corporation, Osaka (JP)

(72) Inventor: Yoshihiro MATSUOKA, Osaka (JP)

(73) Assignee: EXEDY Corporation

(21) Appl. No.: 16/552,591

(22) Filed: Aug. 27, 2019

(30) Foreign Application Priority Data
Oct. 17, 2018 (JP) 2018-195675

(51) Int. Cl. F16F 15/18

(52) U.S. Cl. CPC F16F 15/18; F16D 2300/22

(57) ABSTRACT

A dynamic damper device includes a rotary member, a mass member, and a magnetic damper mechanism. The rotary member includes a first opposed surface. The mass member is disposed to be rotatable together with the rotary member, and rotatable and axially movable relative to the rotary member. The mass member includes a second opposed surface. The second opposed surface is radially opposed at a gap to the first opposed surface. The magnetic damper mechanism includes magnets, and is configured to magnetically couple the rotary member and the mass member by the magnets. The magnetic damper mechanism is configured to generate a resilient force to reduce the relative displacement produced between the rotary member and the mass member in a rotational direction. The first and second opposed surfaces are shaped such that the gap therebetween is variable with an axial movement of either the rotary member or the mass member.

### CROSS-REFERENCE TO RELATED APPLICATIONS

This application claims priority to Japanese Patent Application No. 2018-195675, filed Oct. 17, 2018. The contents of that application are incorporated by reference herein in their entirety.

### TECHNICAL FIELD

The present invention relates to a dynamic damper device, particularly to a dynamic damper device for inhibiting torque fluctuations in a rotary member to which a torque is inputted.

### BACKGROUND ART

For example, a clutch device, including a damper device, and a torque converter are provided between an engine and a transmission in an automobile. Additionally, for reduction in fuel consumption, the torque converter is provided with a lock-up device for mechanically transmitting a torque at a predetermined rotational speed or greater.

In general, the lock-up device includes a clutch part and a damper including a plurality of torsion springs. In the lock-up device described above, torque fluctuations are inhibited by the damper including the plural torsion springs.

Incidentally, a lock-up device described in Japan Laid-open Patent Application Publication No. 2009-293671 is provided with a dynamic damper device including an inertia member so as to inhibit torque fluctuations. The dynamic damper device described in Japan Laid-open Patent Application Publication No. 2009-293671 is provided with coil springs for elastically coupling an output plate and the inertia member in a rotational direction.

As described in Japan Laid-open Patent Application Publication No. 2009-293671, many of the well-known dynamic damper devices have a configuration that the output plate and the inertia member are coupled through the coil springs.

However, in use of the coil springs, a stopper mechanism is required to be provided for preventing the coil springs from being fully compressed in actuation. This results in a drawback that the dynamic damper device is complicated in structure and is also increased in size.

Additionally, there is a drawback that the stopper mechanism is frequently actuated by resonance of the dynamic damper device, whereby hitting sound is produced in actuation of the stopper mechanism.

### BRIEF SUMMARY

It is an object of the present invention to achieve simplification in structure and compactness in size of a dynamic damper device by abolishing installation of a stopper mechanism used so far, and in addition, to eliminate production of hitting sound in the dynamic damper device.

(1) A dynamic damper device according to the present invention includes a rotary member, a mass member and a magnetic damper mechanism. The rotary member is a component to which a torque is inputted, and includes a first opposed surface having an annular shape. The mass member is disposed to be rotatable together with the rotary member, and is disposed to be rotatable and axially movable relative to the rotary member. The mass member includes a second opposed surface having an annular shape. The second opposed surface is radially opposed at a gap to the first opposed surface. The magnetic damper mechanism includes at least one pair of magnets disposed in the rotary member and the mass member. The magnetic damper mechanism magnetically couples the rotary member and the mass member by the at least one pair of magnets. When a relative displacement is produced between the rotary member and the mass member in a rotational direction, the magnetic damper mechanism generates a resilient force serving to reduce the relative displacement. Additionally, the first opposed surface and the second opposed surface are shaped such that the gap therebetween is variable with an axial movement of either the rotary member or the mass member.

In the present device, the rotary member and the mass member are magnetically coupled. In other words, the rotary member and the mass member are coupled in the rotational direction by magnetism. Because of this, when a torque is inputted to the rotary member, the rotary member and the mass member are rotated. When the torque inputted to the rotary member does not fluctuate, relative displacement is not produced between the rotary member and the mass member in the rotational direction. On the other hand, when the torque inputted to the rotary member fluctuates, the relative displacement is produced between the mass member and the rotary member in the rotational direction (the displacement will be hereinafter expressed as “rotational phase difference” on an as-needed basis) depending on the extent of torque fluctuations, because the mass member is disposed to be rotatable relative to the rotary member.

When the torque does not herein fluctuate, in other words, when the rotational phase difference is not produced between the rotary member and the mass member, lines of magnetic force of the at least one pair of magnets disposed in the rotary member and the mass member are in a stable condition. On the other hand, when the rotational phase difference is produced between the rotary member and the mass member, the lines of magnetic force generated by the at least one pair of magnets are distorted, and are in an unstable condition. The lines of magnetic force in the unstable condition are going to restore to the stable condition, whereby the resilient force, by which the rotational phase difference between the rotary member and the mass member becomes “0”, acts on the both. In other words, the resilient force, acting on the rotary member and the mass member, is similar to an elastic force of an elastic member such as a spring. The elastic force is exerted by the elastic member when the elastic member is elastically deformed, and serves to restore the deformed shape of the elastic member to the original shape thereof. Torque fluctuations are inhibited by this resilient force (elastic force).

The rotary member and the mass member are herein magnetically coupled. Hence, it is possible to abolish installation of the coil spring and the stopper mechanism, both of which have been used so far in a well-known device, and to realize simplification in structure and compactness in size of the present device. Besides, by abolishing installation of the stopper mechanism, it is possible to eliminate hitting sound produced so far in actuation of the stopper mechanism in the well-known device.

In the present invention, the mass member can be herein axially moved relative to the rotary member. Because of this, the magnetic damper mechanism can be changed in effective thickness. With change in effective thickness, the resilient force can be changed.

It should be noted that “the effective thickness of the magnetic damper mechanism” refers to the axial length of a region in which rotary member-side one and mass member-side one of the at least one pair of magnets axially overlap as seen in a direction arranged orthogonally to a rotational axis.

Besides in the present invention, the gap between the first opposed surface of the rotary member and the second opposed surface of the mass member is changed with the axial movement of either the rotary member or the mass member. With the change in gap, the resilient force of the magnetic damper mechanism can be changed.

As described above, the mass member is axially moved relative to the rotary member, whereby the effective thickness and the gap between the opposed surfaces of the rotary member and the mass member can be changed. Therefore, with a small amount of axial movement of either the rotary member or the mass member, the resilient force can be greatly changed, and the axial space of the present device can be reduced.

(2) Preferably, the first opposed surface includes a first large diameter portion and a first small diameter portion. The first small diameter portion is disposed in axial alignment with the first large diameter portion, and has a smaller diameter than the first large diameter portion. Additionally, the second opposed surface includes a second large diameter portion radially opposed to the first large diameter portion, and a second small diameter portion that is radially opposed to the first small diameter portion and has a smaller diameter than the second large diameter portion.

When the amount of movement of either the rotary member or the mass member is “0”, the large diameter portions of the first and second opposed surfaces are opposed to each other, while the small diameter portions thereof are opposed to each other. At this time, each of the gap between the large diameter portions and that between the small diameter portions has a predetermined dimension. When either the rotary member or the mass member is axially moved in this condition, part of the large diameter portion of one of the both members and part of the small diameter portion of the other of the both members are opposed to each other. Accordingly, the aforementioned gap having the predetermined dimension is enlarged in part, whereby the resilient force can be changed.

(3) Preferably, each of the first opposed surface and the second opposed surface has a taper shape to be reduced in diameter from a first axial side to a second axial side.

Similarly to the above, the gap between the first opposed surface and the second opposed surface is herein changed with the axial movement of either the rotary member or the mass member. Because of this, the resilient force can be greatly changed.

(4) Preferably, the magnetic damper mechanism includes a plurality of first magnets and a plurality of second magnets. The plurality of first magnets are attached to the rotary member. The plurality of second magnets are attached to the mass member, while being opposed to the plurality of first magnets.

Here, the rotary member and the mass member are magnetically coupled by the plural opposed pairs of first and second magnets. When the rotational phase difference is produced between the rotary member and the mass member by torque fluctuations, lines of magnetic force between each pair of first and second magnets are turned into the unstable condition from the stable condition. Then, the lines of magnetic force are going to restore to the stable condition, whereby the resilient force (the force by which the rotational phase difference between the rotary member and the mass member becomes “0”) acts on the both. Consequently, torque fluctuations are inhibited.

(5) Preferably, the rotary member includes a first holder that has an annular shape and holds the plurality of first magnets. On the other hand, the mass member includes a second holder that has an annular shape and holds the plurality of second magnets. The second holder is disposed on an outer peripheral side of the first holder. Additionally, the first holder includes an outer peripheral surface corresponding to the first opposed surface, whereas the second holder includes an inner peripheral surface corresponding to the second opposed surface.

Here, the second holder of the mass member is disposed on the outer peripheral side of the first holder of the rotary member, while the plurality of first magnets and the plurality of second magnets are disposed in radial opposition to each other. Therefore, increase in axial space of the dynamic damper device can be inhibited.

(6) Preferably, the plurality of first magnets are disposed in circumferential alignment in an outer peripheral part of the rotary member. On the other hand, the plurality of second magnets are disposed in circumferential alignment in an inner peripheral part of the mass member. Additionally, the magnetic damper mechanism further includes flux barriers provided between circumferentially adjacent two of the plurality of first magnets and between circumferentially adjacent two of the plurality of second magnets.

Here, each flux barrier is provided between adjacent two of the magnets. Hence, the roundabout flow of magnetic flux can be prevented at each magnet, and it is possible to strengthen, for instance, either the pull force (force of attraction) between magnets or the resilient force acting on the rotary member and the mass member as much as possible.

It should be noted that the flux barriers can be made of gaps or non-magnetic material such as resin.

(7) Preferably, the plurality of first magnets are disposed such that polarities thereof are alternately disposed in circumferential alignment, while the plurality of second magnets are disposed such that polarities thereof are alternately disposed in circumferential alignment.

(8) Preferably, the plurality of either first or second magnets are each divided into at least two parts opposed to each of the plurality of the other second or first magnets.

When the plurality of first or second magnets are each divided, initial distortion of the lines of magnetic force occurs in the stable condition of the lines of magnetic force, i.e., a condition without rotational phase difference between the rotary member and the mass member. Due to the initial distortion, a preliminary resilient force acts between the rotary member and the mass member even in the condition without rotational phase difference. With the preliminary resilient force described above, the magnitude of torque to torsion angle can be increased in a low torsion angular range, whereby torsional stiffness can be enhanced.

(9) Preferably, the dynamic damper device further includes a moving mechanism axially moving either the rotary member or the mass member.

Overall, according to the present invention described above, installation of a stopper mechanism used so far in a well-known dynamic damper device can be abolished in the present dynamic damper device, whereby simplification in structure and compactness in size of the present dynamic damper device can be achieved. Additionally, it is possible to eliminate hitting sound produced so far in actuation of the stopper mechanism in the well-known dynamic damper device.

Moreover, in the present invention, the resilient force of the magnetic damper mechanism can be controlled, and besides, the resilient force can be greatly changed in an axially small space.

### BRIEF DESCRIPTION OF THE DRAWINGS

FIG. 1 is a cross-sectional configuration view of a dynamic damper device according to a preferred embodiment of the present invention.

FIG. 2 is a partial enlarged view of FIG. 1.

FIG. 3 is a front view of a hub, an inertia member and a magnetic damper mechanism in the dynamic damper device shown in FIG. 1.

FIG. 4 is a diagram showing a magnetic field when a torsion angle of the magnetic damper mechanism is 0 degrees.

FIG. 5 is a diagram showing a magnetic field when the torsion angle of the magnetic damper mechanism is 10 degrees.

FIG. 6 is a torsional characteristic diagram of the preferred embodiment shown in FIG. 1 and modifications 1 and 2.

FIG. 7 is a diagram showing a condition made after movement of a mass member.

FIGS. 8A and 8B are diagrams showing change in air gap between a first holder and a second holder.

FIG. 9 is a control block diagram for driving a moving mechanism.

FIG. 10 is a flowchart of the control block diagram shown in FIG. 9.

FIG. 11 is a diagram according to modification 1 and corresponds to FIG. 3.

FIG. 12 is a diagram according to modification 2 and corresponds to FIG. 3.

FIG. 13 is a diagram according to modification 3 and corresponds to FIG. 3.

FIGS. 14A and 14B are diagrams showing opposed surfaces according to another preferred embodiment.

### DETAILED DESCRIPTION

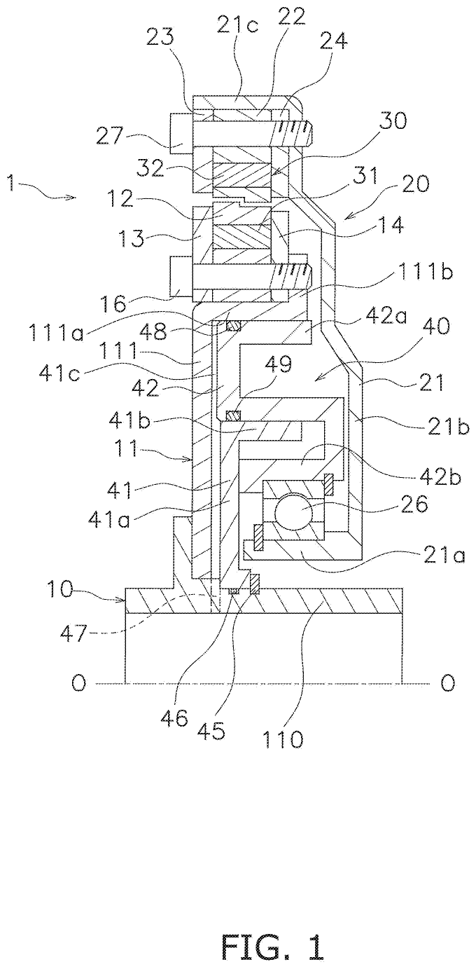

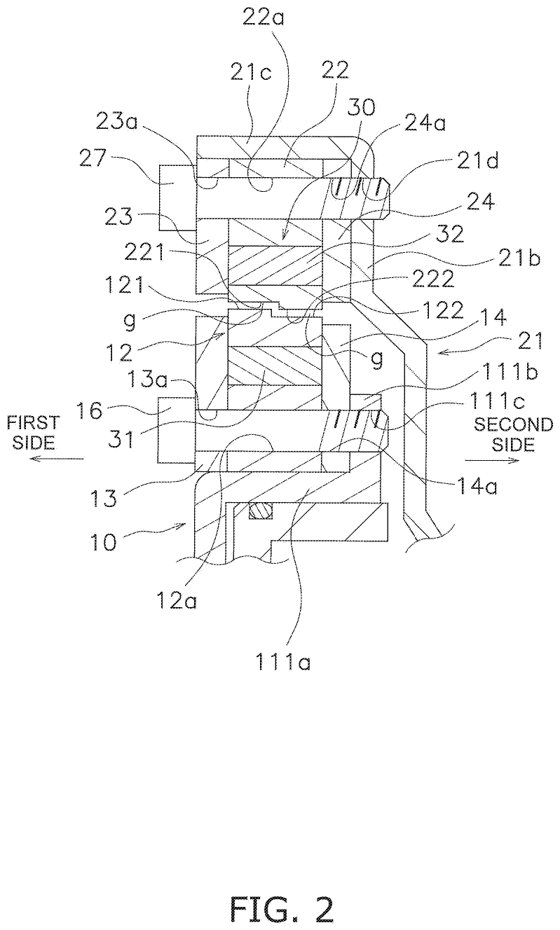

FIG. 1 is a cross-sectional view of a dynamic damper device 1 according to a preferred embodiment of the present invention. In FIG. 1, line O-O indicates a rotational axis. On the other hand, FIG. 2 is an enlarged view of the outer peripheral part of the dynamic damper device 1 shown in FIG. 1.

[Entire Configuration]

The dynamic damper device 1 includes a rotary member 10 to which a torque is inputted, a mass member 20, a magnetic damper mechanism 30 and a moving mechanism 40. The rotary member 10 is provided in, for instance, a lock-up device for a torque converter. Specifically, the torque is inputted to the rotary member 10, for instance, from a front cover through a clutch part and a damper mechanism. The torque, inputted to the rotary member 10, is then transmitted to a transmission-side input shaft.

[Rotary Member 10]

The rotary member 10 includes a first support plate 11, a first holder 12 and a pair of inner peripheral side plates 13 and 14.

The first support plate 11 includes an inner peripheral cylindrical portion 110 and a disc portion 111. The inner peripheral cylindrical portion 110 has an axially extending shape and the center axis thereof is matched with the rotational axis O-O. The disc portion 111 includes a radial support portion 111a in the outer peripheral part thereof. The radial support portion 111a is made in the shape of a tube extending in the axial direction. Additionally, the distal end of the radial support portion 111a is bent to extend radially outward, and is provided as an axial support portion 111b. The axial support portion 111b is provided with screw holes 111c (see FIG. 2) axially penetrating therethrough.

The first holder 12 has an annular shape, and is supported by the outer peripheral surface of the radial support portion 111a of the disc portion 111. The first holder 12 is formed by axially laminating a plurality of plates made of soft magnetic material such as iron. The first holder 12 is provided with holes 12a axially penetrating the inner peripheral part thereof.

Additionally, the outer peripheral surface (exemplary first opposed surface) of the first holder 12 has a stepped shape. As shown close-up in FIG. 2, the first holder 12 includes a first large diameter portion 121 and a first small diameter portion 122 that are disposed in axial alignment. The first large diameter portion 121 is disposed on a first axial side (left side in FIGS. 1 and 2), whereas the first small diameter portion 122 is disposed on a second axial side (right side in FIGS. 1 and 2). The outer diameter of the first large diameter portion 121 is larger than that of the first small diameter portion 122, but the inner diameter of the first large diameter portion 121 is equal to that of the first small diameter portion 122.

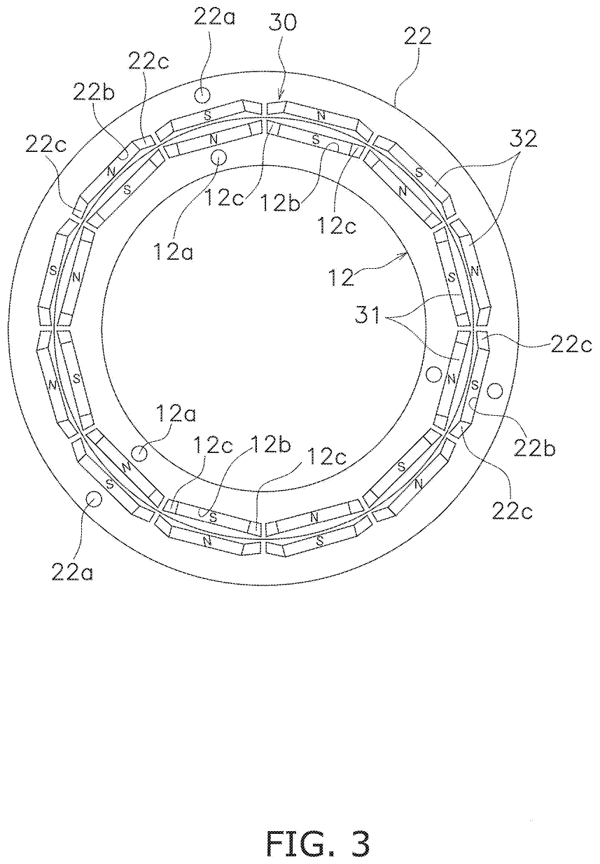

Moreover, as shown in FIG. 3, the first holder 12 is provided with a plurality of first accommodation portions 12b and a plurality of flux barriers 12c on the outer peripheral side of the holes 12a. It should be noted that FIG. 3 only shows the first holder 12, a second holder 22 (to be described) and magnets 31 and 32 accommodated in the first and second holders 12 and 22, while the other members are removed therefrom.

Each first accommodation portion 12b is an opening that has a rectangular shape as seen in a front view and has a predetermined thickness in the radial direction. Additionally, each first accommodation portion 12b axially penetrates the first holder 12. Also, the plural first accommodation portions 12b are disposed in circumferential alignment. One pair of first flux barriers 12c is provided on the both circumferential ends of each first accommodation portion 12b. It should be noted that each first accommodation portion 12b and each pair of first flux barriers 12c are continuously provided, and compose a single opening axially penetrating the first holder 12. In other words, the first flux barriers 12c are herein gaps. It should be noted that non-magnetic material such as resin can be attached, as the first flux barriers 12c, to the first accommodation portions 12b.

The pair of inner peripheral side plates 13 and 14, each having an annular shape, is made of non-magnetic material such as aluminum, and is disposed axially on the both sides of the first holder 12. In other words, the pair of inner peripheral side plates 13 and 14 is disposed to interpose the first holder 12 axially therebetween. As shown in FIG. 2, each of the pair of inner peripheral side plates 13 and 14 is provided with holes 13a, 14a axially penetrating the inner peripheral part thereof. Both the holes 13 and the holes 14 are disposed in corresponding positions to the holes 12a of the first holder 12.

Additionally, the first holder 12 and the pair of inner peripheral side plates 13 and 14 are fixed by bolts 16 penetrating triads of holes 12a, 13a and 14a, respectively. In more detail, the bolts 16 are screwed into the screw holes 111c of the axial support portion 111b, whereby the first holder 12 and the pair of inner peripheral side plates 13 and 14 are fixed to the axial support portion 111b.

With the configuration described above, a unit, composed of the first holder 12 and the pair of inner peripheral side plates 13 and 14, is radially positioned by the radial support portion 111a of the first support plate 11, while being axially positioned by the axial support portion 111b of the first support plate 11.

[Mass Member 20]

The mass member 20 is disposed to be rotatable together with the rotary member 10, and is also disposed to be rotatable and axially movable with respect to the rotary member 10. The mass member 20 includes a second support plate 21, the second holder 22 and a pair of outer peripheral side plates 23 and 24.

The second support plate 21 is rotatably supported by the moving mechanism 40 and the first support plate 11 through a bearing 26. The second support plate 21 includes an inner peripheral support portion 21a, a disc portion 21b and an outer peripheral support portion 21c.

The inner peripheral support portion 21a is made in the shape of a tube that extends in the axial direction, and the center axis thereof is matched with the rotational axis O-O. The bearing 26 is attached to the outer peripheral part of the inner peripheral support portion 21a. The disc portion 21b is shaped to extend radially outward from one end of the inner peripheral support portion 21a. The disc portion 21b is provided with screw holes 21d (see FIG. 2) axially penetrating the outer peripheral part thereof. The outer peripheral support portion 21c is made in the shape of a tube that axially extends from the outer peripheral part of the disc portion 21b.

The second holder 22 has an annular shape, and is supported by the inner peripheral surface of the outer peripheral support portion 21c. Additionally, the second holder 22 is disposed radially outside the first holder 12, while being radially opposed thereto. The second holder 22 is formed by axially laminating a plurality of plates made of soft magnetic material such as iron. The second holder 22 is provided with holes 22a axially penetrating the outer peripheral part thereof.

Additionally, the inner peripheral surface (exemplary second opposed surface) of the second holder 22 has a stepped shape. As shown close-up in FIG. 2, the second holder 22 includes a second large diameter portion 221 and a second small diameter portion 222 that are disposed in axial alignment. The second large diameter portion 221 is disposed on the first axial side, and is radially opposed to the first large diameter portion 121 at a predetermined gap. The second small diameter portion 222 is disposed on the second axial side, and is radially opposed to the first small diameter portion 122 at a predetermined gap. The inner diameter of the second large diameter portion 221 is larger than that of the second small diameter portion 222, but the outer diameter of the second large diameter portion 221 is equal to that of the second small diameter portion 222.

It should be noted that in this example, a gap g between the first large diameter portion 121 and the second large diameter portion 221 is equal to that between the first small diameter portion 122 and the second small diameter portion 222.

Additionally, as shown in FIG. 3, the second holder 22 is provided with a plurality of second accommodation portions 22b and a plurality of second flux barriers 22c on the inner peripheral side of the holes 22a.

Each second accommodation portion 22b is an opening that has a rectangular shape as seen in the front view and has a predetermined thickness in the radial direction. Additionally, each second accommodation portion 22b axially penetrates the second holder 22. Also, the plural second accommodation portions 22b are disposed in circumferential alignment, while being radially opposed to the first accommodation portions 12b, respectively. One pair of second flux barriers 22c is provided on the both circumferential ends of each second accommodation portion 22b. The second flux barriers 22c are openings axially penetrating the second holder 22. In other words, the second flux barriers 22c are herein gaps. It should be noted that non-magnetic material such as resin can be attached, as the second flux barriers 22c, to the second accommodation portions 22b. One pair of second flux barriers 22c is provided to continue to each second accommodation portion 22b, and each is shaped to slant radially inward with separation from the boundary thereof against each second accommodation portion 22b.

The pair of outer peripheral side plates 23 and 24, each having an annular shape, is made of non-magnetic material such as aluminum, and is disposed axially on the both sides of the second holder 22. In other words, the pair of outer peripheral side plates 23 and 24 is disposed to interpose the second holder 22 axially therebetween. As shown in FIG. 2, each of the pair of outer peripheral side plates 23 and 24 is provided with holes 23a, 24a axially penetrating the outer peripheral part thereof. Both the holes 23a and the holes 24a are disposed in corresponding positions to the holes 22a of the second holder 22.

Additionally, the second holder 22 and the pair of outer peripheral side plates 23 and 24 are fixed by bolts 27 penetrating triads of holes 22a, 23a and 24a, respectively. In more detail, the bolts 27 are screwed into the screw holes 21d, whereby the second holder 22 and the pair of outer peripheral side plates 23 and 24 are fixed to the second support plate 21.

With the configuration described above, a unit, composed of the second holder 22 and the pair of outer peripheral side plates 23 and 24, is radially positioned by the outer peripheral support portion 21c of the second support plate 21, while being axially positioned by the disc portion 21b of the second support plate 21.

[Magnetic Damper Mechanism 30]

The magnetic damper mechanism 30 is a mechanism that magnetically couples the rotary member 10 and the mass member 20 and generates a resilient force when relative displacement is produced between the rotary member 10 and the mass member 20 in a rotational direction. The resilient force serves to reduce the relative displacement. Here, the first and second holders 12 and 22 are members on which the magnetic damper mechanism 30 directly acts.

It should be noted that as described above, the expression “magnetically coupling the rotary member 10 (the first holder 12) and the mass member 20 (the second holder 22)” means coupling the both in the rotational direction.

As shown in FIGS. 1 and 2, the magnetic damper mechanism 30 includes a plurality of first magnets 31 and a plurality of second magnets 32. The plural first magnets 31 are disposed in the first accommodation portions 12b of the first holder 12, respectively. On the other hand, the plural second magnets 32 are disposed in the second accommodation portions 22b of the second holder 22, respectively. Therefore, the first magnets 31 and the second magnets 32 are disposed in radial opposition to each other.

The first and second magnets 31 and 32 are permanent magnets formed by neodymium sintered magnets or so forth. As shown in FIG. 3, each opposed pair of first and second magnets 31 and 32 is disposed to have opposite polarities N and S, whereby a pull force (force of attraction) is generated therebetween. Additionally, both the plural first magnets 31 and the plural second magnets 32 are disposed such that the polarities N and S are alternately disposed in circumferential alignment.

[Moving Mechanism 40]

The moving mechanism 40 is a mechanism axially moving the mass member 20 with respect to the rotary member 10. With the moving mechanism 40, the magnetic damper mechanism 30 can be changed in effective thickness. The moving mechanism 40 includes an oil chamber forming member 41 and a piston 42.

The oil chamber forming member 41 is disposed in axial opposition to the inner peripheral part of the first support plate 11 of the rotary member 10. The oil chamber forming member 41 includes a disc portion 41a and a tubular portion 41b.

The disc portion 41a is fixed at the inner peripheral part thereof to the outer peripheral surface of the inner peripheral cylindrical portion 110 of the rotary member 10. In more detail, the inner peripheral cylindrical portion 110 is provided with a step portion and includes a snap ring 45 attached to the outer peripheral surface thereof. The oil chamber forming member 41 is fixed by this step portion and the snap ring 45, while being axially immovable. It should be noted that a seal member 46 is disposed between the inner peripheral surface of the disc portion 41a and the outer peripheral surface of the inner peripheral cylindrical portion 110.

The tubular portion 41b is shaped to axially extend from the outer peripheral part of the disc portion 41a. A cylinder part 41c, which is an annular space, is formed between the tubular portion 41b and the radial support portion 111a of the rotary member 10. It should be noted that the inner peripheral cylindrical portion 110 of the rotary member 10 is provided with an oil pathway 47 for introducing hydraulic oil to the cylinder part 41c.

The piston 42 is disposed axially between the first support plate 11 and the second support plate 21, while being axially movable. The piston 42 includes a body 42a and a support portion 42b.

The body 42a has an annular shape and includes a space in the interior thereof. The body 42a is attached to the cylinder part 41c, while being axially slidable. Seal members 48 and 49 are provided between the outer and inner peripheral surfaces of the body 42a and the cylinder part 41c.

The support portion 42b is provided further radially inward of the body 42a. The support portion 42b is made in the shape of a tube extending in the axial direction, and a bearing 26 is attached between the inner peripheral surface of the support portion 42b and the outer peripheral surface of the inner peripheral support portion 21a of the second support member 21. In other words, the mass member 20 including the second support plate 21 is supported by the rotary member 10 including the first support plate 11 through the bearing 26 and the piston 42, while being rotatable and axially movable.

[Actuation of Magnetic Damper Mechanism 30]

In the present preferred embodiment, a torque is inputted to the rotary member 10 from a drive source such as an engine (not shown in the drawings).

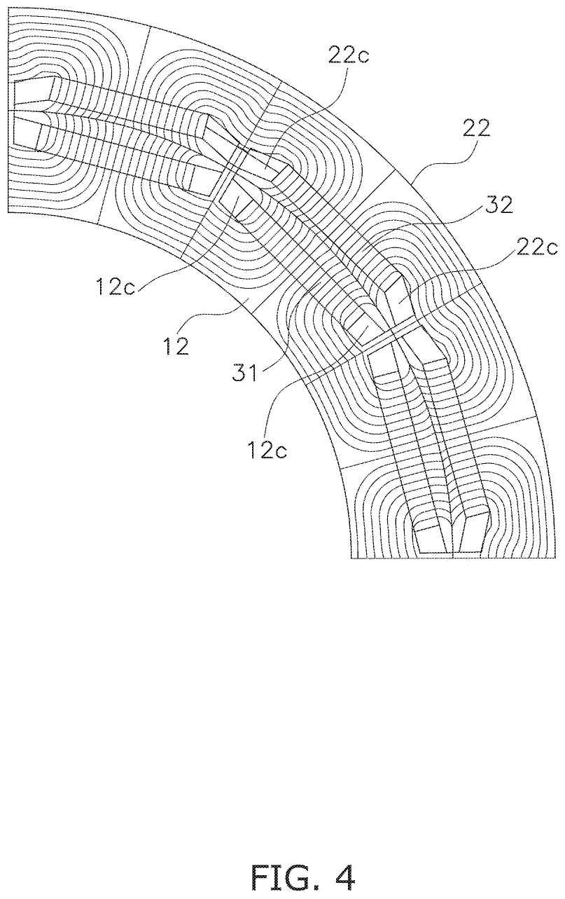

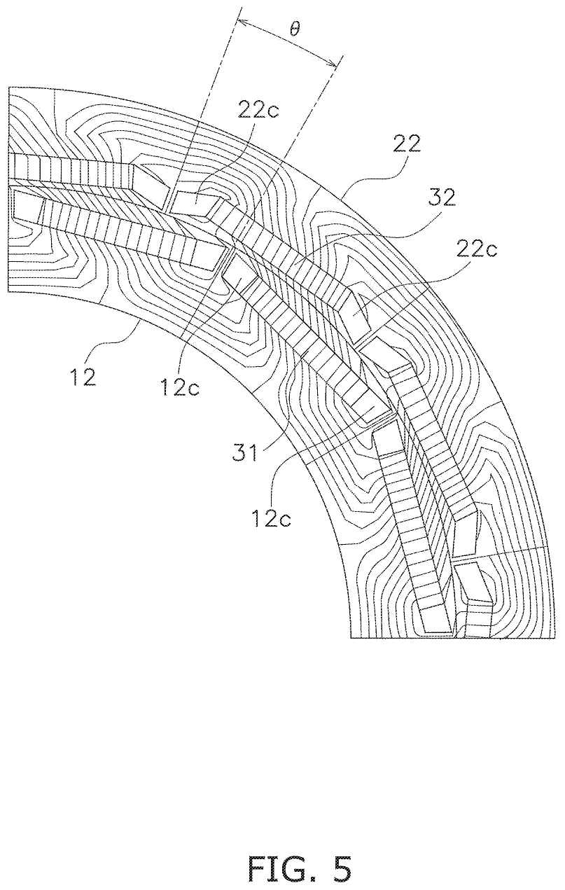

FIGS. 4 and 5 are magnetic field diagrams showing lines of magnetic force between the first magnets 31 and the second magnets 32. It should be noted that in FIGS. 4 and 5, radially extending straight lines are depicted between circumferentially adjacent two of the first magnets 31 and between circumferentially adjacent two of the second magnets 32 for convenience and easy understanding of the rotational phase difference between the first holder 12 and the second holder 22 and a condition of lines of magnetic force. Hence, the radially extending straight lines are not depicted as lines of magnetic force. Additionally, circumferential division of the first holder 12 and that of the second holder 22 are not indicated by the radially extending straight lines.

When torque fluctuations do not exist in torque transmission, the first holder 12 and the second holder 22 are rotated in the condition shown in FIG. 4. In other words, the first holder 12 and the second holder 22 are rotated without relative displacement in the rotational direction (i.e., in a condition that the rotational phase difference is “0”), because the first holder 12 and the second holder 22 are magnetically coupled by the pull forces (forces of attraction) of the first and second magnets 31 and 32 provided in the both holders 12 and 22.

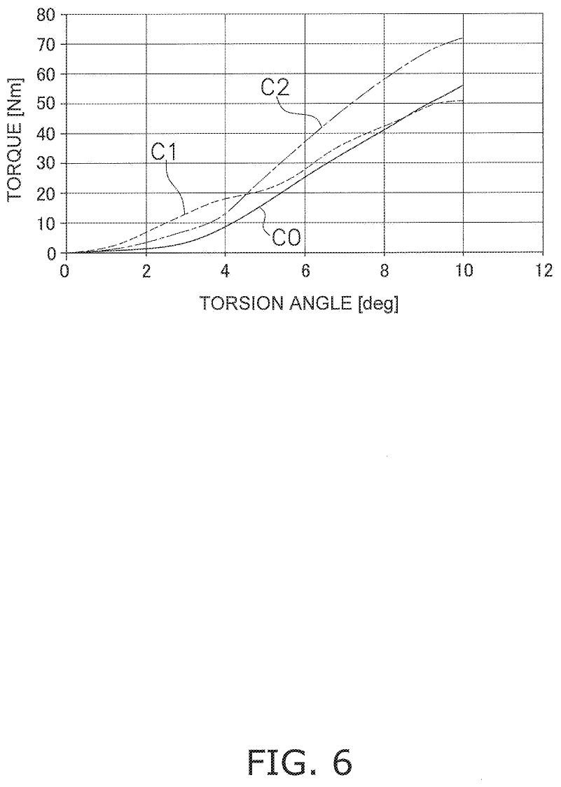

In such a condition that the polarity N of the first magnet 31 and the polarity S of the second magnet 32 are opposed in each pair of first and second magnets 31 and 32 without being displaced in the rotational direction, lines of magnetic force generated by the first and second magnets 31 and 32 are in the most stable condition. This condition corresponds to the origin (where torsion angle is 0 degrees) in the torsional characteristic diagram of FIG. 6.

On the other hand, when torque fluctuations exist in torque transmission, a rotational phase difference θ (of 10 degrees in this example) is produced between the first holder 12 and the second holder 22 as shown in FIG. 5. In this condition, lines of magnetic force generated by the first and second magnets 31 and 32 are distorted, and are in an unstable condition. The lines of magnetic force in the unstable condition are going to restore to the stable condition as shown in FIG. 4, whereby a resilient force is generated. In other words, the resilient force is generated to make the rotational phase difference between the first holder 12 and the second holder 22 “0”. The resilient force corresponds to an elastic force in a heretofore known damper mechanism using torsion springs.

As described above, when the rotational phase difference is produced between the first holder 12 and the second holder 22 by torque fluctuations, the first holder 12 receives the resilient force that is attributed to the first and second magnets 31 and 32 and is directed to reduce the rotational phase difference between the both holders 12 and 22. Torque fluctuations are inhibited by this force.

The aforementioned force for inhibiting torque fluctuations is changed in accordance with the rotational phase difference between the first holder 12 and the second holder 22, whereby torsional characteristic C0 can be obtained as shown in FIG. 6.

[Actuation of Moving Mechanism 40]

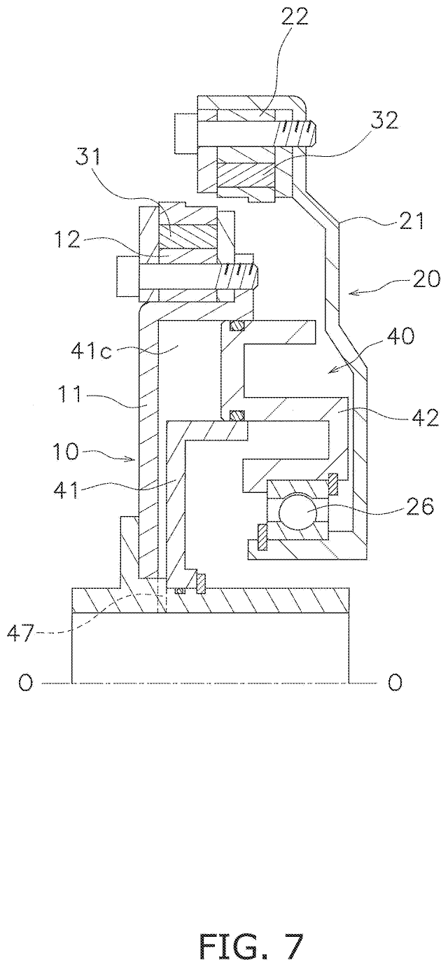

When the hydraulic oil is introduced to the cylinder part 41c through the oil pathway 47, the second holder 22 supported by the second support plate 21 can be axially moved. For example, as shown in FIG. 7, when the second holder 22 is moved to the right side of FIG. 7 with respect to the first holder 12, the magnetic damper mechanism 30 can be reduced in effective thickness (that refers to, as described above, the axial length of a region in which the first magnets 31 and the second magnets 32 axially overlap as seen in a direction arranged orthogonally to the axis). With reduction in effective thickness, it is possible to reduce the magnetic coupling force between the first holder 12 and the second holder 22, i.e. the elastic force (the resilient force). Therefore, the dynamic damper device 1 can be reduced in torsional stiffness. Specifically, the slope of the characteristic shown in FIG. 6 can be made as gentle as possible.

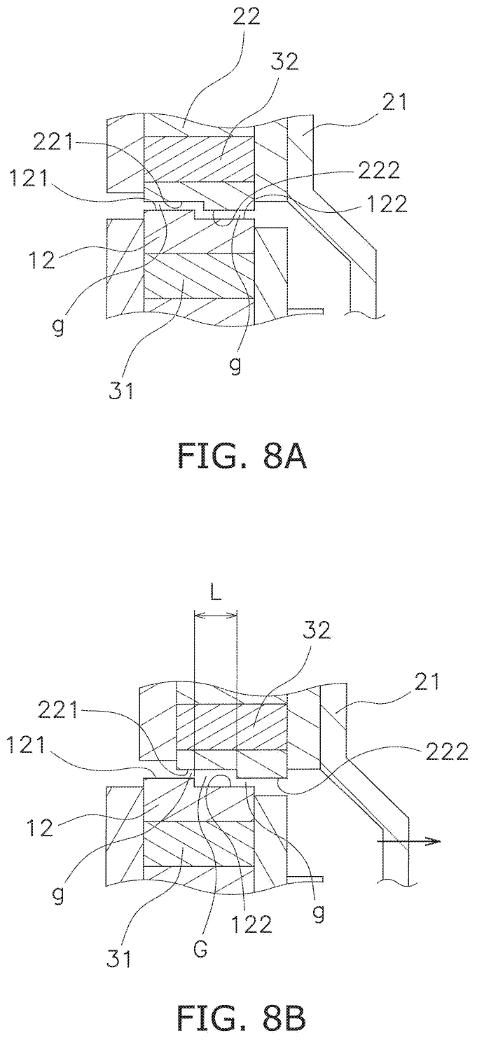

Incidentally, as shown in FIG. 8A, when the first holder 12 and the second holder 22 are located in the same axial position, the radial gap between the first holder 12 and the second holder 22 is entirely made constant in the axial direction as the gap g.

On the other hand, as shown in FIG. 8B, when the mass member 20 is axially moved by the moving mechanism 40, a gap G, which is wider than the gap g, is produced in an axial range L of the opposed surfaces because of the stepped shapes of the opposed surfaces, whereas the gap g is produced in the remaining region of the opposed surfaces. Thus, not only the effective thickness but also the gap between the opposed surfaces, i.e., an air gap, is changed with axial movement of the mass member 20, whereby the resilient force can be greatly changed.

Here, in the example shown in FIGS. 8A and 8B, each of the first and second holders 12 and 22 can be made of a laminated steel plate provided as the large diameter portion 121, 221 and that provided as the small diameter portion 122, 222. In other words, each holder 12, 22 can be made of two sizes of laminated steel plates.

[Driving of Moving mechanism 40 and Control Flowchart]

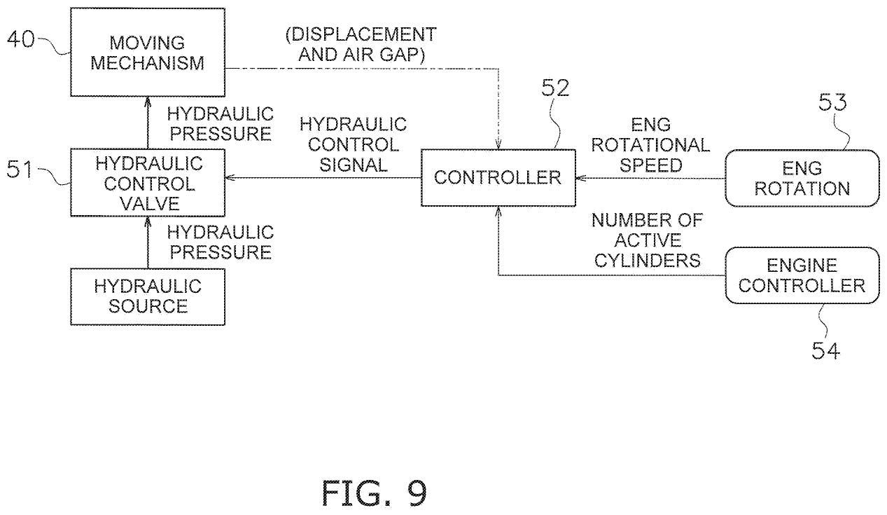

FIG. 9 shows a control block diagram for driving the moving mechanism 40. A hydraulic control valve 51, provided as a drive mechanism, is connected to the moving mechanism 40. Hydraulic pressure is supplied to the hydraulic control valve 51 from a hydraulic source such as an oil pump. Additionally, the hydraulic control valve 51 is controlled by a hydraulic control signal from a controller 52, whereby the hydraulic pressure controlled by the hydraulic control valve 51 is supplied to the oil pathway 47 of the moving mechanism 40.

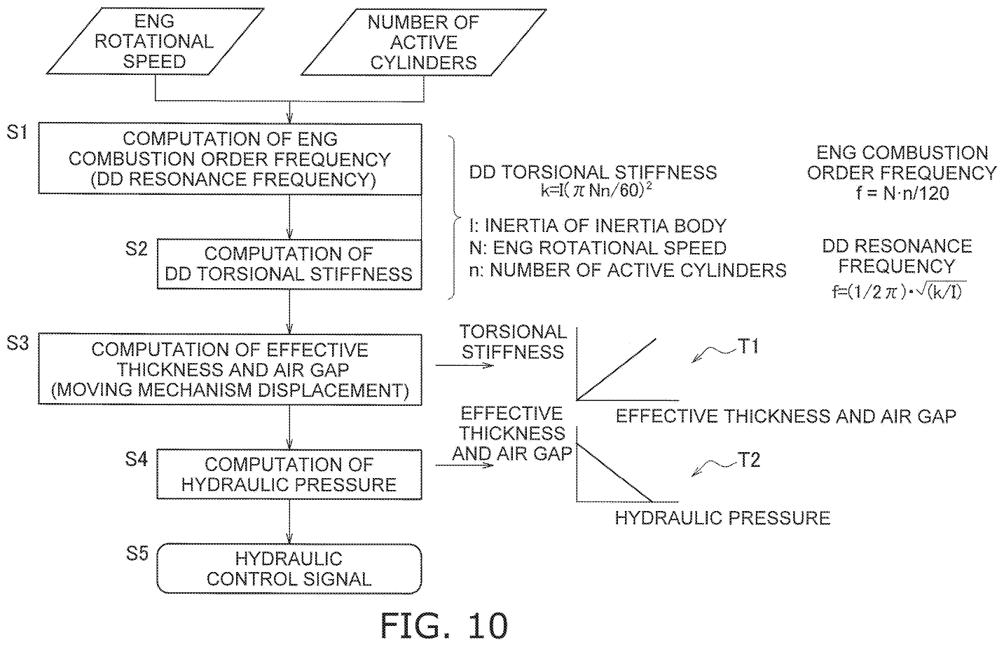

The controller 52 receives, as control parameters, the engine rotational speed inputted from an engine rotational speed sensor 53 and the number of active cylinders inputted from an engine controller 54. Then, by following a flowchart shown in FIG. 10, the controller 52 computes a hydraulic control signal based on the aforementioned control parameters, and outputs the hydraulic control signal to the hydraulic control valve 51. It should be noted that in FIG. 10, the number of active cylinders refers to the number of cylinders actually activated in all the cylinders of the engine.

First, in steps S1 and S2, engine combustion order frequency and dynamic damper torsional stiffness are computed based on the engine rotational speed and the number of active cylinders. As shown in FIG. 10, the following formulas (1) and (2) are herein given:

Engine combustion order frequency f=N·n/120 (1)

Dynamic damper resonance frequency f=(½π)·(k/I)^{1/2} (2)

where I: the amount of inertia of the inertia member 20

N: the engine rotational speed

n: the number of active cylinders

Therefore, based on the formulas (1) and (2), torsional stiffness k of the dynamic damper is computed with the following formula:

Dynamic damper torsional stiffness k=I·(π·N·n/60)²

Next in step S3, as shown in FIG. 10, with reference to table T1, effective thickness is computed based on the dynamic damper torsional stiffness k obtained in step S2. The table T1 has been preliminarily obtained and shows a relation between effective thickness (and air gap) and torsional stiffness. It should be noted that in the present preferred embodiment, when the effective thickness is set, the air gap is set as well. Hence, the effective thickness and the air gap will be hereinafter simply referred to as “effective thickness”.

Furthermore in step S4, with reference to table T2, hydraulic pressure is computed based on the effective thickness obtained in step S3. The table T2 has been preliminarily obtained and shows a relation between hydraulic pressure and effective thickness. Then in step S5, a hydraulic control signal is computed. The hydraulic control valve 51 is controlled by the hydraulic control signal.

It should be noted that as shown with dashed two-dotted line in FIG. 9, the effective thickness or displacement in movement attributed to the moving mechanism 40 can be configured to be detected and inputted to the controller 52, and the controller 52 can be configured to perform feedback control based on the detection result.

As described above, with the moving mechanism 40 being provided, the effective thickness and the gap of the magnetic damper mechanism 30 can be changed, and the torsional stiffness of the dynamic damper device 1 can be set to an arbitrary characteristic.

### Modifications 1, 2 and 3

In the example of FIG. 3, the second magnets 32 are disposed in opposition to the first magnets 31 on a one-to-one basis. However, one of each pair of first and second magnets 31 and 32 can be divided.

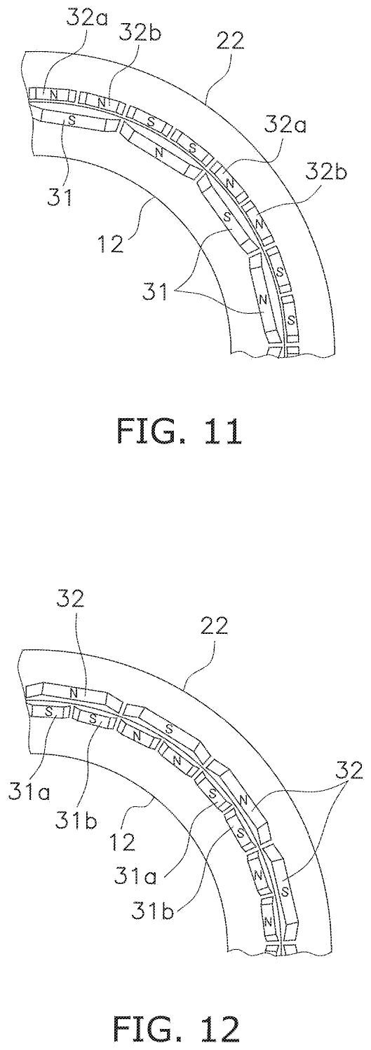

For example, in modification 1 shown in FIG. 11, two second magnets 32a and 32b are disposed in opposition to one first magnet 31. On the other hand, in modification 2 shown in FIG. 12, one second magnet 32 is disposed in opposition to two first magnets 31a and 31b.

According to these examples shown in FIGS. 11 and 12, in the stable condition as shown in FIG. 4, in other words, in the condition without rotational phase difference between the first and second holders 12 and 22, initial distortion is supposed to be caused in lines of magnetic force. A preliminary resilient force (a resilient force generated in the stable condition) is generated by this initial distortion. Therefore, torsional stiffness can be enhanced. For example, as shown in FIG. 6, the value of torque to torsion angle can be enhanced from characteristic C0 to characteristic C1 in a low torsion angular range of 0 to 4 degrees. It should be noted that in the torsional characteristics of modifications 1 and 2, the value of torque is “0” at a torsion angle of 0 degrees. This is because initial distortions (preliminary resilience forces) of the divided magnets are directed oppositely, and are thereby canceled out.

FIG. 6 shows torsional characteristics of the examples shown in FIGS. 3, 11 and 12. Characteristic C0 indicates the characteristic of the example shown in FIG. 3; characteristic C1 indicates the characteristic of modification 1 shown in FIG. 11; and characteristic C2 indicates the characteristic of modification 2 shown in FIG. 12.

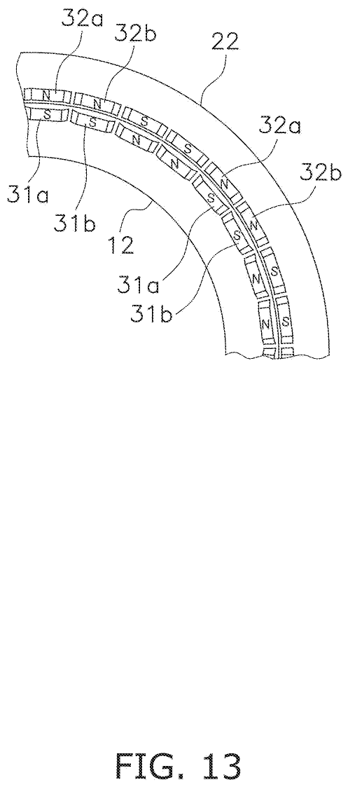

Furthermore, as shown in FIG. 13, each first magnet 31 can be divided, and likewise, each second magnet 32 can be divided. The divided parts of each first magnet 31 can be disposed in opposition to those of each second magnet 32. In short, in the example shown in FIG. 13, two first magnets 31a and 31b each having the S polarity are disposed in opposition to two second magnets 32a and 32b each having the N polarity. Moreover, in each of the first and second holders 12 and 22, a plurality of sets of two magnets having the same polarity are circumferentially disposed in alternate alignment of “two magnets 31a and 31b (32a and 32b) having the S polarity→two magnets 31a and 31b (32a and 32b) having the N polarity→two magnets 31a and 31b (32a and 32b) having the S polarity . . . ”.

### Other Preferred Embodiments

The present invention is not limited to the preferred embodiment described above, and a variety of changes or modifications can be made without departing from the scope of the present invention.

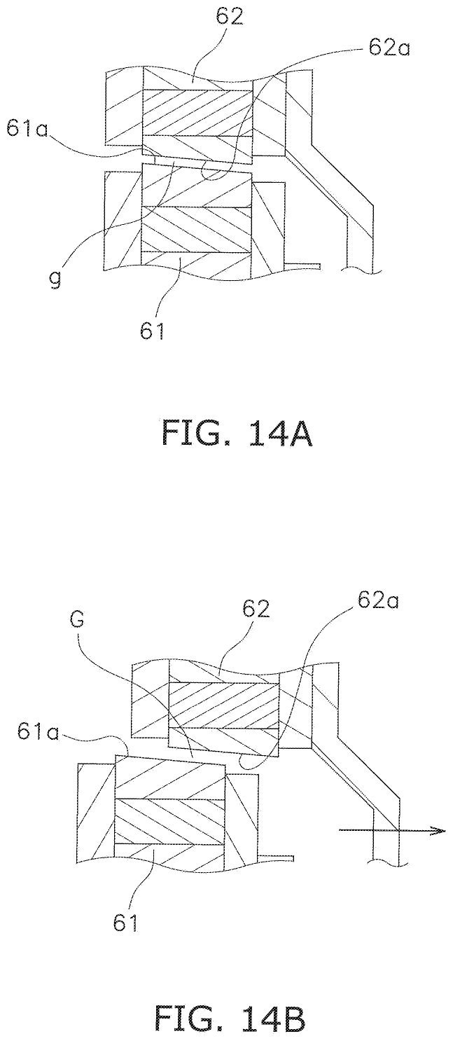

(a) FIGS. 14A and 14B show another practical example of the opposed surfaces of the respective holders. In this example, as shown in FIG. 14A and FIG. 14B, even when an outer peripheral surface 61a (exemplary first opposed surface) of the first holder 61 and an inner peripheral surface 62a (exemplary second opposed surface) of the second holder 62 are shaped to taper off, it is possible to obtain advantageous effects similar to those achieved as described above. In this example, the outer peripheral surface 61a of the first holder 61 is shaped to have a diameter gradually reducing from the first axial side to the second axial side. Likewise, the inner peripheral surface 62a of the second holder 62 is shaped to have a diameter gradually reducing from the first axial side to the second axial side.

In the configuration described above, as shown in FIG. 14A, when the first holder 61 and the second holder 62 are located in the same axial position, the radial gap between the both corresponds to the gap g. On the other hand, as shown in FIG. 14B, when the mass member is axially moved by the moving mechanism, the gap g is widened and changed into the gap G. Besides, the effective thickness is also changed and reduced. Thus, the air gap and the effective thickness are changed with axial movement of the mass member, whereby the resilient force can be greatly changed.

(b) In the modifications shown in FIGS. 11 to 13, either or both of each first magnet and each second magnet are designed to be divided into two parts. However, the number of parts obtained as a result of dividing each first or second magnet and so forth are not limited to those exemplified in the modifications shown in FIGS. 11 to 13. For example, one of each first magnet and each second magnet can be divided into two (or three) parts, whereas the other can be divided into three (or two) parts.

(c) In the aforementioned preferred embodiment, the mass member is axially moved with respect to the rotary member. However, the rotary member can be axially moved, while the mass member is fixed.

### REFERENCE SIGNS LIST

1 Dynamic damper device
10 Rotary member
11 First support plate
12, 61 First holder
121 First large diameter portion
122 First small diameter portion
12c First flux barrier
20 Mass member
21 Second support plate
22 Second holder
221 Second large diameter portion
222 Second small diameter portion
22c Second flux barrier
30 Magnetic damper mechanism
31, 31a, 31b First magnet
32, 32a, 32b Second magnet
40 Moving mechanism

What is claimed is:

1. A dynamic damper device comprising:
a rotary member to which a torque is inputted, the rotary member including a first opposed surface having an annular shape;
a mass member disposed to be rotatable together with the rotary member, the mass member disposed to be rotatable and axially movable relative to the rotary member, the mass member including a second opposed surface having an annular shape, the second opposed surface radially opposed at a gap to the first opposed surface; and
a magnetic damper mechanism including at least one pair of magnets disposed in the rotary member and the mass member, the magnetic damper mechanism configured to magnetically couple the rotary member and the mass member by the at least one pair of magnets, the magnetic damper mechanism configured to generate a resilient force when a relative displacement is produced between the rotary member and the mass member in a rotational direction, the resilient force serving to reduce the relative displacement, wherein
the first opposed surface and the second opposed surface are shaped such that the gap therebetween is variable with an axial movement of either the rotary member or the mass member.

2. The dynamic damper device according to claim 1, wherein
the first opposed surface includes
a first large diameter portion, and
a first small diameter portion disposed in axial alignment with the first large diameter portion, the first small diameter portion having a smaller diameter than the first large diameter portion, and
the second opposed surface includes
a second large diameter portion radially opposed to the first large diameter portion, and
a second small diameter portion radially opposed to the first small diameter portion, the second small diameter portion having a smaller diameter than the second large diameter portion.

3. The dynamic damper device according to claim 1, wherein each of the first opposed surface and the second opposed surface has a taper shape to be reduced in diameter from a first axial side to a second axial side.

4. The dynamic damper device according to claim 1, wherein the magnetic damper mechanism includes
a plurality of first magnets attached to the rotary member, and
a plurality of second magnets attached to the mass member, the plurality of second magnets opposed to the plurality of first magnets.

5. The dynamic damper device according to claim 4, wherein
the rotary member includes a first holder having an annular shape, the first holder holding the plurality of first magnets, the first holder including an outer peripheral surface corresponding to the first opposed surface, and
the mass member includes a second holder having an annular shape, the second holder holding the plurality of second magnets, the second holder disposed on an outer peripheral side of the first holder, the second holder including an inner peripheral surface corresponding to the second opposed surface.

6. The dynamic damper device according to claim 4, wherein
the plurality of first magnets are disposed in circumferential alignment in an outer peripheral part of the rotary member,
the plurality of second magnets are disposed in circumferential alignment in an inner peripheral part of the mass member, and
the magnetic damper mechanism further includes flux barriers provided between circumferentially adjacent two of the plurality of first magnets and between circumferentially adjacent two of the plurality of second magnets.

7. The dynamic damper device according to claim 4, wherein the plurality of first magnets are disposed such that polarities thereof are alternately disposed in circumferential alignment, the plurality of second magnets disposed such that polarities thereof are alternately disposed in circumferential alignment.

8. The dynamic damper device according to claim 4, wherein the plurality of either first or second magnets are each divided into at least two parts, the at least two parts opposed to each of the plurality of the other second or first magnets.

9. The dynamic damper device according to claim 1, further comprising:
a moving mechanism axially configured to move either the rotary member or the mass member.
